(19) United States
(12) Patent Application Publication
(10) Pub. No.: US 2003/0055597 A1
(43) Pub. Date: Mar. 20, 2003

(54) Vehicle orientation sensor

(76) Inventor: Axel H Berndorfer, El Paso, TX (US)

Correspondence Address: MARGARET A. DOBROWITSKY, DELPHI TECHNOLOGIES, INC, Legal Staff, P.O. Box 5052, Mail Code 480-414-420, Troy, MI, 48007-5052, US

(21) Appl. No.: 09/955,708

(22) Filed: Sep. 19, 2001

(51) Int. Cl. G01C 9/00

(52) U.S. Cl. 702/150

(57) ABSTRACT

A vehicle orientation sensor includes a housing having a concave upper surface. Four contacts are disposed on the upper surface. The contacts are electrically isolated. A steel ball is placed in the center of the upper surface. When a vehicle in which the orientation sensor is installed is parked on an incline, the steel ball makes contact with two of the four contacts to close a circuit. A microprocessor connected to the orientation sensor can determine when the vehicle is parked on an incline by the closure of the circuit. Thus, an oil level measured while the vehicle is parked on an incline can be disregarded or compensated therefor.

### TECHNICAL FIELD

The present invention relates generally to engine oil sensors.

### BACKGROUND OF THE INVENTION

Many modem motor vehicles are equipped with sensors that sense the level of oil in a vehicle oil pan. For the most accurate measurement of the oil level, the vehicle should be level. Unfortunately, as recognized by the present invention, the position of the vehicle is unknown to the sensor. Thus, if the vehicle is, e.g., parked on an incline or a curb, the oil pan will not be level and the measurement of the oil level will be incorrect.

Systems have been provided that take multiple readings and then average the readings in order to compensate for inaccurate readings. Alternatively, systems have been provided in which the level sensor is placed as close to the centroid of the oil pan as possible. Either of these solutions can be quite complex and expensive.

The present invention has recognized these prior art drawbacks, and has provided the below-disclosed solutions to one or more of the prior art deficiencies.

### SUMMARY OF THE INVENTION

A vehicle orientation sensor for determining when a vehicle is parked on an incline includes a housing that forms a concave upper surface. Three contacts are disposed on the concave upper surface. Moreover, a conductive ball is rollably disposed on the upper surface. When the vehicle is parked on an incline, the conductive ball competes a circuit across two of the three contacts.

In a preferred embodiment, the concave upper surface forms a central dimple in which the ball rests when the vehicle is parked on a level surface. Preferably, the sensor includes a microprocessor that is connected to the contacts. The microprocessor determines when the ball completes a circuit across two of the three contacts in order to determine when the vehicle is parked on an incline. In a preferred embodiment, the sensor also includes an oil level sensor that is connected to the microprocessor. When the microprocessor determines that the vehicle is parked on a level surface, it receives a signal from the oil level sensor that represents an oil level measurement.

In one aspect of the present invention, the contacts include a first contact pad, a second contact pad, a third contact pad, and a fourth contact pad that are disposed on the upper concave surface. In this aspect, the contact pads are connected to the microprocessor by a first resistor, a second resistor, a third resistor, and a fourth resistor, respectively. Also, the resistors have different resistance values.

In another aspect of the present invention, the contacts include a first contact pole, a second contact pole, a third contact pole, and a fourth contact pole that extend from the upper concave surface. The contact poles are connected to the microprocessor by a first resistor, a second resistor, a third resistor, and a fourth resistor, respectively. In this aspect, the resistors have different resistance values.

In yet another aspect of the present invention, a system for measuring oil level in a vehicle oil pan includes a vehicle orientation sensor and an oil level sensor. A microprocessor is connected to the vehicle orientation sensor and the oil level sensor. In this aspect of the present invention, the microprocessor includes a program for determining when the vehicle is parked on a level surface and measuring the oil level in the oil pan in response to the determining act.

In still another aspect of the present invention, a vehicle orientation sensor for determining when a vehicle is parked on an incline includes a housing that forms a concave upper surface. This aspect includes means for establishing two open electric circuits on the concave upper surface and means for selectively closing either of the open circuits.

The present invention will now be described, by way of example, with reference to the accompanying drawings, in which:

### BRIEF DESCRIPTION OF THE DRAWINGS

FIG. 1 is an overhead schematic view of a vehicle orientation sensor;

FIG. 2 is a cross-section view of the vehicle orientation sensor taken along line 2-2 in FIG. 1;

FIG. 3 is an overhead schematic view of an alternative vehicle orientation sensor; and

FIG. 4 is a cross-section view of the alternative vehicle orientation sensor taken along line 4-4 in FIG. 3.

### DESCRIPTION OF AN EMBODIMENT OF THE INVENTION

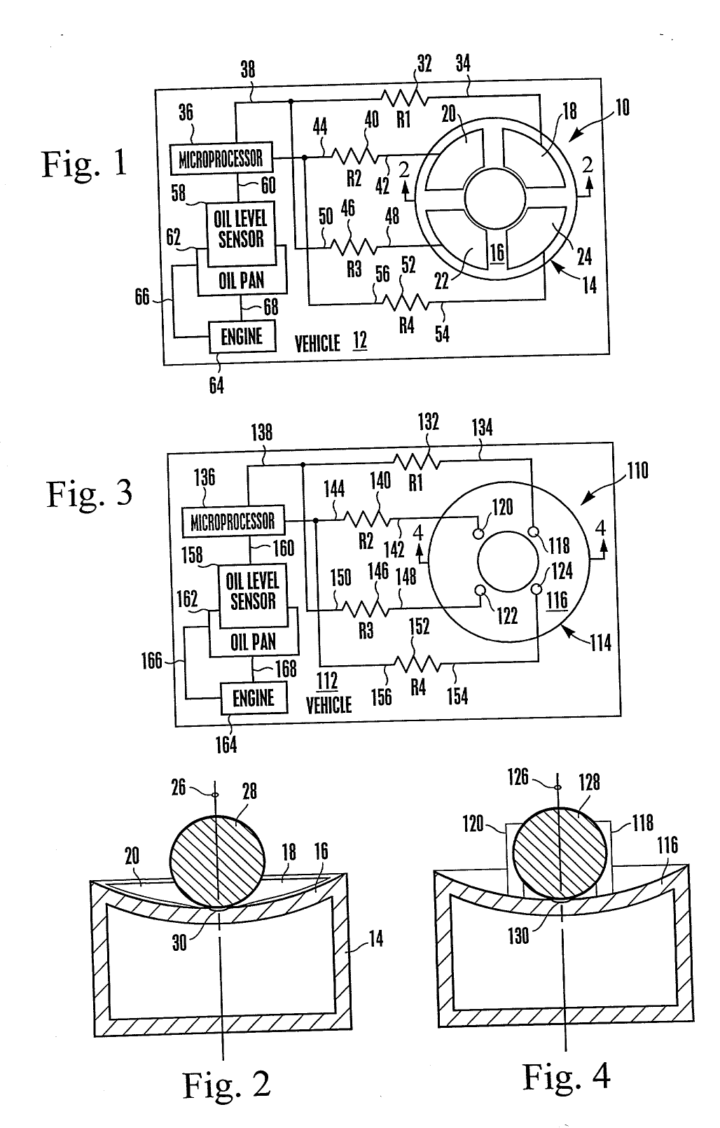

Referring initially to FIGS. 1 and 2, a vehicle orientation sensor is shown and generally designated 10. FIG. 1 shows that the sensor 10 is installed in a vehicle 12. Moreover, FIGS. 1 and 2 show that the sensor 10 includes a generally cylindrical housing 14 having a generally concave upper surface 16. In a preferred embodiment, the housing 14 is integrated into the upper portion of an oil level sensor, described below. FIG. 1 shows a first flat contact pad 18, a second flat contact pad 20, a third flat contact pad 22 and a fourth flat contact pad 24 attached to and conforming with or otherwise incorporated into the concave upper surface 16. As described in detail below, the contact pads 18, 20, 22, 24 are electrically connected to a microprocessor and electrically isolated from each other. As shown, the contact pads 18, 20, 22, 24 are equidistantly spaced around the center of the upper surface 16. It can be appreciated that the contact pads 18, 20, 22, 24 are slightly raised so that the ball, described below, touches them as it rolls across them or between them.

Referring briefly to FIG. 2, the sensor 10 defines a central axis 26. As shown, a preferably steel ball 28 is placed on the upper surface 16 such that the center of the ball 28 is aligned with the central axis 26. It is to be appreciated that the ball can be made of other electrically conductive materials if desired. The upper surface 16 of the housing 14 is formed with a very shallow, central dimple 30 in which the ball 28 rests to keep ball 28 from contacting any of the contact pads 18, 20, 22, 24 when the vehicle 12 is on a flat, level surface. It is to be appreciated that the dimple 30 is not required, however, the shape of the dimple, e.g., the depth or diameter of the dimple 30, can be used to control the angle at which the vehicle must surpass before the ball 28 rolls out of the dimple 30 to contact the contact pads 18, 20, 22, 24.

Referring back to FIG. 1, the first contact pad 18 is connected to a first resistor 32 by electrical line 34. The first resistor 32, in turn, is connected to a microprocessor 36 by electrical line 38. As shown in FIG. 1, the second contact pad 20 is connected to a second resistor 40 by electrical line 42. In turn, the second resistor 40 is connected to the microprocessor 36 by electrical line 44. FIG. 1 further shows that the third contact pad 22 is connected to a third resistor 46 by electrical line 48. The third resistor 46 is connected to the microprocessor 36 by electrical line 50 and electrical line 38. As shown in FIG. 1, the fourth contact pad 24 is connected to a fourth resistor 52 by electrical line 54. In turn, the fourth resistor 52 is connected to the microprocessor 36 via electrical line 56 and electrical line 44. Thus, two separate circuits, each having two legs, are established. As described in detail below, any one of the circuits can be completed by the steel ball 28 contacting any two adjacent contact pads 18, 20, 22, 24. It can be appreciated that the contact pads 18, 20, 22, 24 can be connected directly to the microprocessor 36 without the resistors 32, 40, 46, 52.

Still referring to FIG. 1, the microprocessor 36 is connected to an oil level sensor 58 via electrical line 60. The level sensor 58 is disposed in an oil pan 62. As shown, the oil pan 62 provides oil to an engine 64 via fluid line 66. A return fluid line 68 connects the engine 64 back to the oil pan 62.

Referring to FIGS. 3 and 4, an alternative embodiment of the vehicle orientation sensor is shown and generally designated 110. FIG. 3 shows that the sensor 110 is installed in a vehicle 112. Moreover, FIGS. 3 and 4 show that the sensor 110 includes a generally cylindrical housing 114 having a generally concave upper surface 116. FIG. 1 shows a first vertically-oriented, elongated metal contact pole 118, a second vertically-oriented, elongated metal contact pole 120, a third vertically-oriented, elongated metal contact pole 122 and a fourth vertically-oriented, elongated metal contact pole 124 extending from the concave upper surface 116. As described in detail below, the contact poles 118, 120, 122, 124 are electrically connected to a microprocessor, and are identical to each other and equidistantly spaced around the periphery of the ball, described below.

FIG. 4 shows that the sensor 110 defines a central axis 126. As shown, a preferably steel ball 128 is placed on the upper surface 116 such that the center of the ball 128 is aligned with the central axis 126. The upper surface 116 is formed with a very shallow, central dimple 130 that keeps the steel ball 128 from contacting any of the contact poles 118, 120, 122, 124 when the vehicle 112 is on a flat, level surface.

FIG. 3 shows that the first contact pole 118 is connected to a first resistor 132 by electrical line 134. The first resistor 132, in turn, is connected to a microprocessor 136 by electrical line 138. As shown in FIG. 3, the second contact pole 120 is connected to a second resistor 140 by electrical line 142. In turn, the second resistor 140 is connected to the microprocessor 136 by electrical line 144. FIG. 3 further shows that the third contact pole 122 is connected to a third resistor 146 by electrical line 148. The third resistor 146 is connected to the microprocessor 136 by electrical line 150 and electrical line 138. As shown in FIG. 3, the fourth contact pole 124 is connected to a fourth resistor 152 by electrical line 154. In turn, the fourth resistor 152 is connected to the microprocessor 136 via electrical line 156 and electrical line 144.

Still referring to FIG. 3, the microprocessor 136 is connected to an oil level sensor 158 via electrical line 160. The level sensor 158 is disposed in an oil pan 162. As shown, the oil pan 162 provides oil to an engine 164 via fluid line 166. A return fluid line 168 connects the engine 164 back to the oil pan 162.

Operation

It is to be understood that both embodiments of the present invention operate in the same manner. For ease of discussion, only the operation of the embodiment of the vehicle orientation sensor shown in FIGS. 1 and 2 is described below.

When the vehicle 12 is parked on a flat, level surface, the steel ball 28 rests in the dimple 30 formed in the upper surface 16 of the housing 14, as shown in FIG. 2. However, when the vehicle 12 is parked on an incline, i.e., an incline steep enough to cause the steel ball 28 to roll out of the dimple 30, the steel ball 28 will contact either the first contact pad 18 and the second contact pad 20, or the second contact pad 20 and the third contact pad, or the third contact pad 22 and the fourth contact pad 24, or the fourth contact pad 24 and the first contact pad 18. It can readily be appreciated in reference to FIG. 1 that when the steel ball 28 contacts two pads 18, 20, 22, 24 at the same time, a circuit is completed. Thus, by sensing the completion of the circuit, the microprocessor 36 is able to determine whether the vehicle 12 is parked on an incline. Accordingly, when the vehicle 12 is parked on an incline, the microprocessor 36 will know that an oil level signal from the oil level sensor 58 does not represent an accurate measurement of the oil level in the oil pan 62. The microprocessor 36 can disregard the signal or otherwise adjust the signal to compensate for the inaccuracy.

If the resistors 32, 40, 46, 52 incorporated into the sensor 10 are chosen so that they have different resistance values, the microprocessor 36 can measure the resistance across a circuit created by, e.g., the first contact pad 28, the second contact pad 20, the steel ball 28 and the microprocessor 36 to determine in which direction the vehicle 12 is inclined, either to the front, to the back, the driver's side, or to the passenger's side.

It is to be appreciated that three contact pads can be used in lieu of four contact pads 18, 20, 22, 24 as shown in FIG. 1 or in the alternative, more than four contact pads 18, 20, 22, 24 can be used. Moreover, it is to be appreciated that each contact pad 18, 20, 22, 24 can be separated into concentric bands of contact pads. Thus, as the angle of inclination of the vehicle 12 increases in any direction, the steel ball 28 can roll from one band of contact pads to another band of contact pads and the microprocessor 36 can determine when a certain critical inclination angle has been exceeded. It is also to be appreciated that the vehicle orientation sensor 12 can be installed the housing of an existing oil level sensor or it can be a separate component distanced from the oil level sensor.

With the configuration of structure and logic described above, it is to be appreciated that the vehicle orientation sensor 10 can be used to determine when the vehicle 12 is parked on a flat, level surface. A microprocessor 36 connected to the vehicle orientation sensor 10 and an oil level sensor 58 can give priority to signals received from the oil level sensor 58 when the orientation sensor 10 indicates that the vehicle 12 is parked on a flat, level surface. Thus, the accuracy of the oil level in the vehicle oil pan 64 is increased.

While the particular VEHICLE ORIENTATION SENSOR as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

1. A vehicle orientation sensor for determining when a vehicle is parked on an incline, the sensor comprising:
a housing, the housing being at least partially incorporated into an oil level sensor;
a concave upper surface formed by the housing;
at least three contacts disposed on the concave upper surface; and
a conductive ball rollably disposed on the upper surface, the conductive ball completing a circuit across two of the three contacts when the vehicle is parked on an incline.

2. The sensor of claim 1, wherein the concave upper surface forms a central dimple in which the ball rests when the vehicle is parked on a level surface.

3. The sensor of claim 1, further comprising:
a microprocessor connected to the contacts, the microprocessor determining when the ball completes a circuit across two of the three contacts.

4. The sensor of claim 3, further comprising:
an oil level sensor connected to the microprocessor, the microprocessor determining when the vehicle is parked on a level surface and receiving a signal from the oil level sensor representing an oil level measurement.

5. The sensor of claim 1, wherein the contacts include a first contact pad, a second contact pad, a third contact pad, and a fourth contact pad disposed on the upper concave surface.

6. The sensor of claim 5, wherein the first contact pad is connected to the microprocessor by a first resistor, the second contact pad is connected to the microprocessor by a second resistor, the third contact pad is connected to the microprocessor by a third resistor, and the fourth contact pad is connected to the microprocessor by a fourth resistor.

7. The sensor of claim 6, wherein the resistors have different resistance values.

8. The sensor of claim 1, wherein the contacts include a first contact pole, a second contact pole, a third contact pole, and a fourth contact pole extending from the upper concave surface.

9. The sensor of claim 8, wherein the first contact pole is connected to the microprocessor by a first resistor, the second contact pole is connected to the microprocessor by a second resistor, the third contact pole is connected to the microprocessor by a third resistor, and the fourth contact pole is connected to the microprocessor by a fourth resistor.

10. The sensor of claim 9, wherein the resistors have different resistance values.

11. A system for measuring oil level in a vehicle oil pan, comprising:
a vehicle orientation sensor;
an oil level sensor, the vehicle orientation sensor being at least partially incorporated into the oil level sensor; and
a microprocessor connected to the vehicle orientation sensor and the oil level sensor, the microprocessor including a program for determining when the vehicle is parked on a level surface and measuring the oil level in the oil pan in response to the determining act.

12. The system of claim 11, wherein the orientation sensor includes a ball rollably disposed on a support surface.

13. The system of claim 11, wherein the vehicle orientation sensor comprises:
a housing;
a concave upper surface formed by the housing;
at least three contacts disposed on the concave upper surface; and
a conductive ball rollably disposed on the upper surface, the microprocessor comprising logic means for determining when the conductive ball completes a circuit across two of the three contacts to indicate that the vehicle is parked on an incline.

14. The sensor of claim 13, wherein the concave upper surface forms a central dimple in which the ball rests when the vehicle is parked on a level surface, the microprocessor further comprising logic means for determining when the ball is disposed in the dimple.

15. A vehicle orientation sensor for determining when a vehicleis parked on an incline, the sensor comprising:
a housing, the housing being at least partially incorporated into an oil level sensor;
a concave upper surface formed by the housing;
means for establishing at least two open electric circuits on the concave upper surface; and
means for selectively closing at least one of the open electric circuits.

16. The sensor of claim 15, wherein the concave upper surface includes means for keeping both electric circuits open.

17. The sensor of claim 15, further comprising:
means for determining when one of the open circuits is closed.

18. The sensor of claim 15, further comprising:
means for determining when both circuits are open.

19. The sensor of claim 18, further comprising:
means for measuring oil level in an oil pan when both circuits are open.
